(19) United States
(12) Patent Application Publication
(10) Pub. No.: US 2003/0020532 A1
(43) Pub. Date: Jan. 30, 2003

(54) System for a constant current source

(76) Inventor: Takao Akaogi, Cupertino, CA (US)

Correspondence Address: Daniel D. Tagliaferri, Coudert Brothers, Third Floor, 600 Beach Street, San Francisco, CA, 94109, US

(21) Appl. No.: 09/916,972

(22) Filed: Jul. 27, 2001

(51) Int. Cl. G05F 3/02

(52) U.S. Cl. 327/427

(57) ABSTRACT

A system for a constant current source circuit utilizing CMOS technology. The system includes a constant current source circuit that includes a bias circuit that outputs a bias signal and a switch circuit that has a switch input coupled to receive the bias signal, a switch output, and a switch control that is coupled to receive an input signal. The current source circuit also includes an output circuit that has a first input coupled to the switch output and a second input coupled to the input signal. The output circuit provides an output signal that has constant current.

### FIELD OF THE INVENTION

The present invention relates to current sources, and more particularly, to a constant current source using CMOS technology.

### BACKGROUND OF THE INVENTION

Typically, the use of NMOS components made it relatively easy to realize a constant current source. FIG. 1 shows an NMOS transistor 100 configured as a typical constant current source. The gate terminal 102 is connected to the source terminal 104 so that the gate to source voltage (Vgs) equals zero. Since the transistor 100 has a negative voltage threshold (Vt), constant drain current is available. This typical constant current source has been widely used to make an RC time constant that is independent of the power supply (Vcc).

FIG. 2 shows an RC circuit 200 that uses the typical constant current source circuit of FIG. 1. The circuit 200 includes NMOS transistor 202 that forms the constant current source and transistor 204 that receives a control input 206. The circuit 200 also includes a timing capacitor 208 couple to output 210. During operation, the constant current source 202 provides constant current to charge the timing capacitor 208 and thereby form a consistent output signal.

FIG. 3 shows graph 300 of the output of the RC circuit 200 of FIG. 2 plotted against time. As indicated at 302, when the input signal is at a high level (in H), the output signal approaches zero. As indicated at 304, when the input signal is at a low level (in L), the output signal rises at a constant rate as a result of the constant current source providing constant current. For example, dv/dt at the output is a constant, since a constant current is received by the capacitor 208. Thus, the constant current source allows many useful circuits to be constructed, such as the constant current RC circuit.

However, as technology has migrated to utilizing CMOS processes and components, the negative threshold NMOS transistor has become generally unavailable. Therefore, it is desirable to have a way to obtain a constant current source utilizing CMOS technology.

### SUMMARY OF THE INVENTION

The present invention includes a system for providing a constant current source utilizing CMOS technology. The system includes a CMOS circuit that replaces typical NMOS circuits to produce a constant current.

In one embodiment of the invention, a CMOS circuit that operates as a constant current source is provided. The circuit comprises a bias circuit that includes a bias output terminal. The bias circuit produces a bias signal that is output at the bias output terminal. The circuit also includes a switch circuit having a switch input terminal coupled to the bias output terminal to receive the bias signal. The switch circuit also includes a switch output terminal and a switch control terminal that is coupled to receive an input signal, and wherein the bias signal is switched to the switch output terminal to form a switched bias signal in response to the input signal. The circuit also includes an output circuit having a first input terminal coupled to the switch output terminal to receive the switched bias signal, a second input terminal coupled to receive the input signal and an output terminal. The output circuit operates to produce an output signal that has constant current at the output terminal.

In one embodiment of the invention, a method for generating constant current from a CMOS circuit is provided. The method comprises the steps of generating a bias signal, switching the bias signal in response to an input signal, wherein a switched bias signal is produced, and receiving the input signal and the switched bias signal to produced an output signal that provides constant current.

### BRIEF DESCRIPTION OF THE DRAWINGS

The forgoing aspects and the attendant advantages of this invention will become more readily apparent by reference to the following detailed description when taken in conjunction with the accompanying drawings wherein:

FIG. 1 shows an NMOS transistor configured as a typical constant current source;

FIG. 2 shows an RC circuit that uses the typical constant current source circuit of FIG. 1;

FIG. 3 shows graph of the output of the RC circuit of FIG. 2 plotted against time;

FIG. 4 shows one embodiment of a CMOS circuit that operates as a constant current source in accordance with the present invention; and

FIG. 5 shows an RC circuit that utilizes one embodiment of a CMOS constant current source constructed in accordance with the present invention.

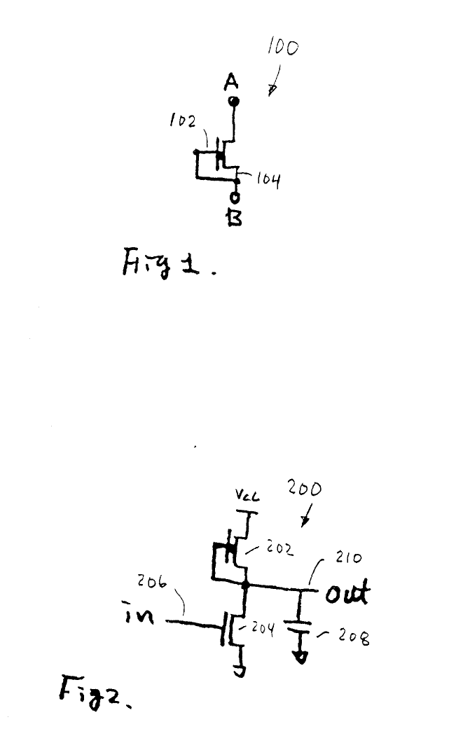

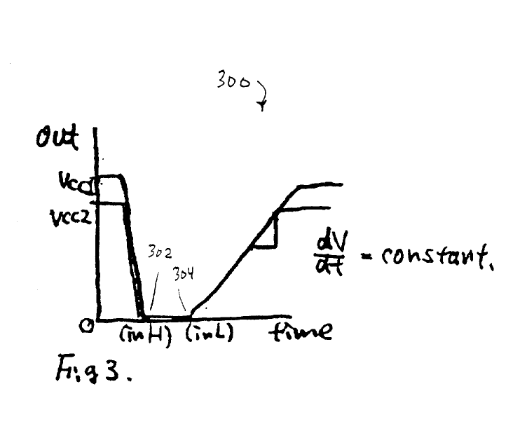

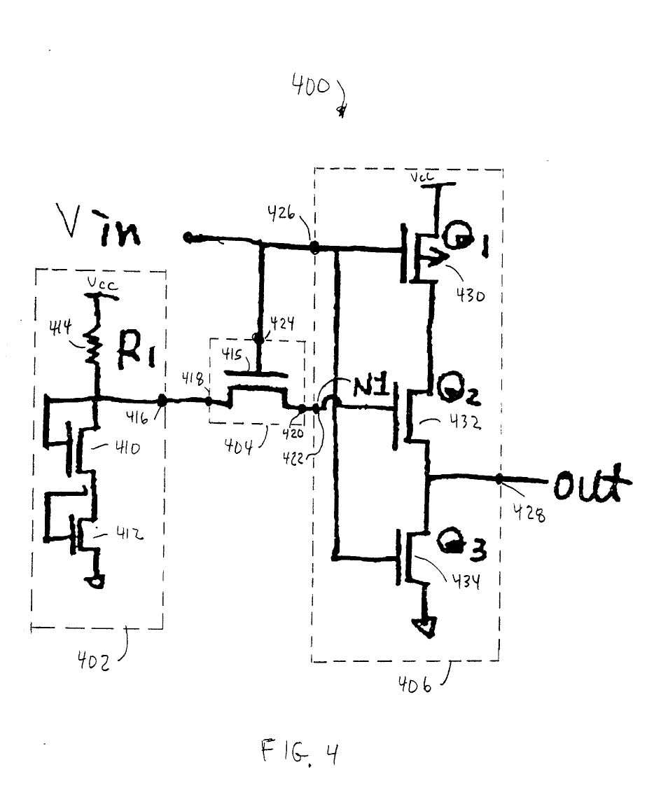

### DETAILED DESCRIPTION OF THE INVENTION

The present invention includes a CMOS constant current source circuit. One or more embodiments included in the present invention will now be described, however, it is possible to make changes and variations to the described embodiments without deviating from the scope of the present invention.

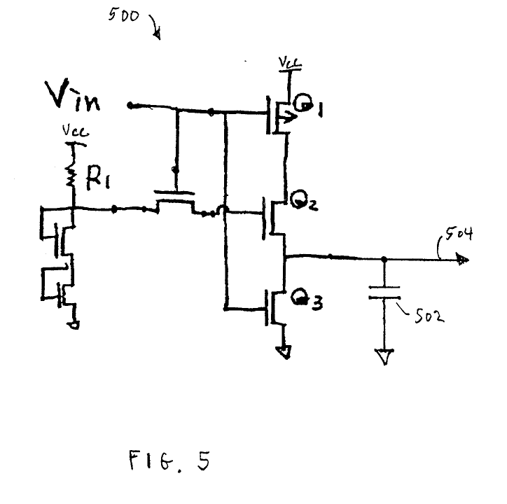

FIG. 4 shows one embodiment of a CMOS circuit 400 that operates as a constant current source in accordance with the present invention. The circuit 400 includes a bias circuit 402, a switch circuit 404 and an output circuit 406.

The bias circuit 402 includes a bias output terminal 416. In one embodiment, the bias circuit is formed by N channel transistor 410, N channel transistor 412 and resistor 414. The bias circuit 402 sets a bias voltage level that is output at the bias output terminal 416.

The switch circuit 404 includes a switch input terminal 418, a switch output terminal 420 and a switch control terminal 424. In one embodiment, the switch circuit 404 is formed by N channel transistor 415 that has a drain terminal coupled to the switch input terminal 418, a source terminal coupled to the switch output terminal 420 and a gate terminal coupled to the switch control terminal 424. The switch input terminal 418 is coupled to the bias output terminal 416. The switch control terminal is coupled to an input signal (Vin) and the switch output terminal 420 is coupled to a first input terminal 422 of the output section 406.

The output circuit 406 includes the first input terminal 422 (also referred to as node N1), a second input terminal 426 and an output terminal 428. In one embodiment the output circuit 406 includes P channel transistor 430, N channel transistor 432, and N channel transistor 434 that are coupled together to produce an output signal (out) that provides a constant current at the output terminal 428. The first input terminal 422 (N1) is coupled to the switch output terminal 420. The second input terminal 426 is coupled to the input signal Vin.

During operation of the circuit 400, when the input signal Vin is at a high level, the output signal (out) at output terminal 428 is low and node N1 has a voltage level that is set to 2*Vtn, where Vtn is equivalent to the threshold voltage (Vt) of an N-channel transistor. When the Vin signal goes to a low level, node N1 is isolated while the output signal at terminal 428 starts going high. As the output voltage goes high, node N1 level is coupled high due to the channel capacitance of transistor 432. As a result, the voltage Vn1 on node N1 is described by;

Vn1=2*Vtn+Vout

Thus, the gate to source voltage of transistor 432 is kept less than or equal to Vtn. Assuming the transistor 432 is operating in saturation mode, constant current is available at the output terminal 428.

FIG. 5 shows an RC circuit 500 that utilizes one embodiment of a CMOS constant current source constructed in accordance with the present invention. The circuit 200 also includes a timing capacitor 502 couple to output 504. During operation, the constant current source provides constant current to charge the timing capacitor and thereby form a constant dv/dt across capacitor 502.

The present invention includes a constant current source that utilizes CMOS technology. The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. Accordingly, the disclosures and descriptions herein are intended to be illustrative, but not limiting, of the scope of the invention which is set forth in the following claims.

What is claimed is:

1. A CMOS circuit that operates as a constant current source, the circuit comprising:
a bias circuit that includes a bias output terminal, the bias circuit produces a bias signal that is output at the bias output terminal;
a switch circuit having a switch input terminal coupled to the bias output terminal to receive the bias signal, the switch circuit also includes a switch output terminal and a switch control terminal, the switch control terminal is coupled to receive an input signal, and wherein the bias signal is switched to the switch output terminal to form a switched bias signal in response to the input signal;
an output circuit having a first input terminal coupled to the switch output terminal to receive the switched bias signal, a second input terminal coupled to receive the input signal, and an output terminal, the output circuit operates to produce an output signal that has constant current at the output terminal.

2. The circuit of claim 1, wherein the bias circuit comprises:
a resistor coupled to a power supply;
a first CMOS transistor coupled to the resistor at the bias output terminal; and
a second CMOS transistor coupled to the first CMOS transistor and also to a system ground.

3. The circuit of claim 2, wherein the switch circuit comprises a third CMOS transistor that includes a drain terminal coupled to the switch input terminal, a source terminal coupled to the switch output terminal and a gate terminal coupled to the switch control terminal.

4. The circuit of claim 3, wherein the output circuit comprises:
a fourth CMOS transistor coupled to a supply voltage and the second input terminal to receive the input signal;
a fifth CMOS transistor coupled to the fourth CMOS transistor and also coupled to the first input terminal to receive the switched bias signal; and
a sixth CMOS transistor coupled to the second input terminal to receive the input signal and to a system ground, and also coupled to the fifth CMOS transistor at the output terminal.

5. The circuit of claim 1, wherein the switch circuit comprises a first CMOS transistor that includes a drain terminal coupled to the switch input terminal, a source terminal coupled to the switch output terminal and a gate terminal coupled to the switch control terminal.

6. The circuit of claim 5, wherein the output circuit comprises:
a second CMOS transistor coupled to a supply voltage and the second input terminal to receive the input signal;
a third CMOS transistor coupled to the second CMOS transistor and also coupled to the first input terminal to receive the switched bias signal; and
a fourth CMOS transistor coupled to the second input terminal to receive the input signal and to a system ground, and also coupled to the third CMOS transistor at the output terminal.

7. The circuit of claim 1, wherein the output circuit comprises:
a first CMOS transistor coupled to a supply voltage and the input signal;
a second CMOS transistor coupled to the first CMOS transistor and also coupled to the switch output terminal; and
a third CMOS transistor coupled to the input signal and a system ground, and also coupled to the second CMOS transistor at the output terminal.

8. The circuit of claim 7, wherein the bias circuit comprises:
a resistor coupled to a power supply;
a fourth CMOS transistor coupled to the resistor at the bias output terminal; and
a fifth CMOS transistor coupled to the fourth CMOS transistor and also to a system ground.

9. A method for generating constant current from a CMOS circuit, the method comprising steps of:
generating a bias signal;
switching the bias signal in response to an input signal, wherein a switched bias signal is produced; and
receiving the input signal and the switched bias signal to produced an output signal that provides constant current.

10. The method of claim 9, wherein the CMOS circuit includes a bias circuit, a switch circuit and an output circuit, and the method comprises steps of:
generating a bias signal at the bias circuit;
receiving an input signal;
switching the bias signal at the switch circuit in response to the input signal, wherein a switched bias signal is produced;
receiving the input signal and the switched bias signal at the output circuit; and
producing an output signal that provides constant current at the output circuit.
